(19) United States
(12) Patent Application Publication
(10) Pub. No.: US 2014/0272558 A1
(43) Pub. Date: Sep. 18, 2014

(54) ELECTRODE FOR A LITHIUM-BASED SECONDARY ELECTROCHEMICAL DEVICE AND METHOD OF FORMING SAME

(71) Applicant: GM GLOBAL TECHNOLOGY OPERATIONS LLC, Detroit, MI (US)

(72) Inventors: Xingcheng Xiao, Troy, MI (US); Mei Cai, Bloomfield Hills, MI (US); Li Yang, Troy, MI (US); Meng Jiang, Rochester Hills, MI (US)

(73) Assignee: GM GLOBAL TECHNOLOGY OPERATIONS LLC, Detroit, MI (US)

(21) Appl. No.: 13/826,168

(22) Filed: Mar. 14, 2013

(51) Int. Cl. H01M 4/139; H01M 10/28; H01M 4/13

(52) U.S. Cl. CPC H01M 4/139; H01M 4/13; H01M 10/28
USPC 429/211; 427/123

(57) ABSTRACT

An electrode for a lithium-based secondary electrochemical device includes a current collector. The current collector includes a substrate having a surface defining a plurality of pores therein, and a lithium powder disposed within each of the plurality of pores. In addition, the electrode includes a cured film disposed on the current collector and formed from an electrically-conductive material. A lithium-based secondary electrochemical device including the electrode, and a method of forming the electrode are also disclosed.

### TECHNICAL FIELD

The disclosure generally relates to an electrode for a lithium-based secondary electrochemical device and to a method of forming the electrode.

### BACKGROUND

Electrochemical devices, such as batteries and supercapacitors, are useful for converting chemical energy into electrical energy, and may be described as primary or secondary. Primary electrochemical devices are generally non-rechargeable, whereas secondary electrochemical devices are readily rechargeable and may be restored to a full charge after use. As such, secondary electrochemical devices may be useful for applications such as powering electronic devices, tools, machinery, and vehicles. For example, secondary electrochemical devices for vehicle applications may be recharged external to the vehicle via a plug-in electrical outlet, or onboard the vehicle via a regenerative event.

One type of secondary electrochemical device, a lithium-based secondary electrochemical device, may include a negative electrode or anode, a positive electrode or cathode, and an electrolyte disposed between the positive and negative electrodes. The negative electrode may incorporate and release lithium ions during charging and discharging of the lithium-based secondary electrochemical device. More specifically, during charging of the lithium-based secondary electrochemical device, lithium ions may move from the positive electrode to the negative electrode. Conversely, during discharge of the secondary electrochemical device, lithium ions may be released from the negative electrode and move to the positive electrode.

### SUMMARY

An electrode for a lithium-based secondary electrochemical device includes a current collector. The current collector includes a substrate having a surface defining a plurality of pores therein, and a lithium powder disposed within each of the plurality of pores. The electrode also includes a cured film disposed on the current collector and formed from an electrically-conductive material.

A method of forming an electrode for a lithium-based secondary electrochemical device includes defining a plurality of pores in a surface of a substrate, and inserting a lithium powder into each of the plurality of pores to form a current collector. After inserting, the method includes forming a cured film comprising an electrically-conductive material on the current collector to thereby form the electrode.

A lithium-based secondary electrochemical device includes a positive electrode, a negative electrode spaced opposite the positive electrode, and a separator positioned between the positive electrode and the negative electrode. At least one of the positive electrode and the negative electrode includes a current collector. The current collector includes a substrate having a surface defining a plurality of pores therein, and a lithium powder disposed within each of the plurality of pores. The at least one of the positive electrode and the negative electrode also includes a cured film disposed on the current collector and formed from an electrically-conductive material.

The detailed description and the drawings or Figures are supportive and descriptive of the disclosure, but the scope of the disclosure is defined solely by the claims. While some of the best modes and other embodiments for carrying out the claims have been described in detail, various alternative designs and embodiments exist for practicing the disclosure defined in the appended claims.

### BRIEF DESCRIPTION OF THE DRAWINGS

FIG. 1 is a schematic exploded perspective illustration of a lithium-based secondary electrochemical device including an electrode;

FIG. 2 is a schematic illustration of a cross-sectional view of the electrode of FIG. 1 taken along section line 2-2;

FIG. 3 is a schematic illustration of a cutaway view of the lithium-based secondary electrochemical device of FIG. 1;

FIG. 4 is a schematic flowchart of a method of forming the electrode of FIGS. 1-3; and

FIG. 5A is a schematic illustration of a cross-sectional view of a substrate of the electrode of FIGS. 1-3;

FIG. 5B is a schematic illustration of a cross-sectional view of a surface of the substrate of FIG. 5A defining a plurality of pores therein;

FIG. 5C is a schematic illustration of a cross-sectional view of a lithium powder disposed within each of the plurality of pores of FIG. 5B;

FIG. 5D is a schematic illustration of a cross-sectional view of a sealing layer disposed on the lithium powder and the surface of FIGS. 5B and 5C;

FIG. 6 is a scanning electron micrograph of the surface of FIG. 5B; and

FIG. 7 is a schematic illustration of a cross-sectional view of another embodiment of the electrode of FIG. 1.

### DETAILED DESCRIPTION

Referring to the Figures, wherein like reference numerals refer to like elements, an electrode 10, 110 of a lithium-based secondary electrochemical device 12 is shown generally in FIG. 1. The electrode 10, 110 may be useful for applications requiring lithium-based secondary electrochemical devices 12 having excellent electrical conductivity, energy density, mechanical integrity, specific energy capacity, performance, and operating life. As used herein, the terminology “lithium-based” generally refers to secondary electrochemical devices 12, such as batteries and capacitors, that operate through lithium dissolution. For example, such lithium-based secondary electrochemical devices 12 may include, but are not limited to, lithium-ion batteries, lithium-sulfur batteries, and lithium-ion supercapacitors. Therefore, the electrode 10, 110 may be useful for a variety of applications requiring lithium-based secondary electrochemical devices 12, such as, but not limited to, electronic devices, tools, machinery, and vehicles. For example, the electrode 10, 110 may be useful for lithium-based secondary electrochemical devices 12 for electric and hybrid electric vehicles. However, it is to be appreciated that the electrode 10, 110 may also be useful for non-automotive applications, such as, but not limited to, household and industrial power tools and electronic devices.

Referring to FIG. 1, for purposes of general explanation, a lithium-based secondary electrochemical module for an automotive application is shown generally at 14. The lithium-based secondary electrochemical module 14 may be useful for, for example, a plug-in hybrid electric vehicle (PHEV). Further, a plurality of secondary electrochemical modules 14 may be combined to form a lithium-based secondary electrochemical pack 16, as shown in FIG. 1. By way of example, the lithium-based secondary electrochemical module 14 may be sufficiently sized to provide a necessary voltage for powering a hybrid electric vehicle (HEV), an electric vehicle (EV), a plug-in hybrid electric vehicle (PHEV), and the like, e.g., approximately 300 to 400 volts or more, depending on the required application.

Referring again to FIG. 1, the lithium-based secondary electrochemical module 14 includes a plurality of lithium-based secondary electrochemical devices 12 positioned adjacent to and spaced from one another. Further, each lithium-based secondary electrochemical device 12 may have a plurality of electrodes 10, 110, e.g., a positive electrode 110 or cathode and a negative electrode 10 or anode. The electrode 10, 110 described herein may be the positive electrode 110 or the negative electrode 10 of the lithium-based secondary electrochemical device 12, depending upon the required configuration and application of the lithium-based secondary electrochemical device 12. However, for ease and economy of description, the negative electrode 10 of the lithium-based secondary electrochemical device 12 is described below.

The lithium-based secondary electrochemical device 12 may be suitable for stacking. That is, the lithium-based secondary electrochemical device 12 may be formed from a heat-sealable, flexible foil that is sealed to enclose at least a portion of the electrodes 10, 110 and a separator 18 (FIG. 3), as set forth in more detail below. Therefore, any number of lithium-based secondary electrochemical devices 12 may be stacked or otherwise placed adjacent to each other to form a cell stack, i.e., the lithium-based secondary electrochemical module 14. Further, although not shown in FIG. 1, additional layers, such as, but not limited to, frames and/or cooling layers may also be positioned in the space between individual lithium-based secondary electrochemical devices 12. The actual number of lithium-based secondary electrochemical devices 12 may be expected to vary with the required voltage output of each lithium secondary electrochemical module 14. Likewise, the number of interconnected secondary electrochemical modules 14 may vary to produce the necessary total output voltage for a specific application.

Further, although not shown, the lithium-based secondary electrochemical device 12 may generally be configured in one of four ways: (1) as a small, solid-body cylinder such as a laptop computer battery; (2) as a large, solid-body cylinder having a threaded terminal; (3) as a soft, flat pouch having flat terminals flush to a body of the device requiring power, such as a cell phone battery, and (4) as a plastic case having large terminals in the form of aluminum and copper sheets, such as secondary electrochemical packs 16 for automotive vehicles. In general, the lithium-based secondary electrochemical device 12 may be connected in a circuit to either discharge the lithium-based secondary electrochemical device 12 via a load (not shown) present in the circuit, or charge the lithium-based secondary electrochemical device 12 by connecting to an external power source (not shown).

With continued reference to FIG. 3, one configuration for the lithium-based secondary electrochemical device 12 is illustrated generally. The lithium-based secondary electrochemical device 12 includes a positive electrode 110 and a negative electrode 10 spaced opposite the positive electrode 110. Further, the lithium-based secondary electrochemical device 12 includes the separator 18, which may be formed from a polymer. The positive electrode 110, negative electrode 10, and separator 18 may be wound together or stacked in alternation inside of a cell enclosure 20, and an electrolyte solution may fill the cell enclosure 20. Further, the separator 18 may be electrically-nonconductive and ion-pervious. For example, the separator 18 may be a microporous polypropylene or polyethylene sheet, and may be surrounded by a nonaqueous lithium salt electrolyte solution to allow for conduction of lithium ions between the positive electrode 110 and the negative electrode 10. Further, the negative electrode 10 may include a negative electrode current collector 22, and the positive electrode 110 may include a positive electrode current collector 122, as set forth in more detail below.

With continued reference to FIG. 3, the separator 18 may be permeable to ensure lithium ion transport between the positive electrode 110 and the negative electrode 10. Nonlimiting examples of suitable separator materials include polyolefins, which may be a homopolymer or a random or block copolymer, either linear or branched, including polyethylene, polypropylene, and blends and copolymers of these; polyethylene terephthalate, polyvinylidene fluoride, polyamides (nylons), polyurethanes, polycarbonates, polyesters, polyetheretherketones (PEEK), polyethersulfones (PES), polyimides (PI), polyamide-imides, polyethers, polyoxymethylene (acetal), polybutylene terephthalate, polyethylene naphthenate, polybutene, acrylonitrile-butadiene styrene copolymers (ABS), styrene copolymers, polymethyl methacrylate, polyvinyl chloride, polysiloxane polymers (such as polydimethylsiloxane (PDMS)), polybenzimidazole, polybenzoxazole, polyphenylenes, polyarylene ether ketones, polyperfluorocyclobutanes, polytetrafluoroethylene (PTFE), polyvinylidene fluoride copolymers and terpolymers, polyvinylidene chloride, polyvinylfluoride, liquid crystalline polymers, polyaramides, polyphenylene oxide, and combinations of these.

Further, the separator 18 (FIG. 3) may be a woven or nonwoven single layer or a multi-layer laminate fabricated in either a dry or wet process. For example, in one example, the separator 18 may be a single layer of polyolefin. In another example, the separator 18 may be a single layer of one or more polymers. As another example, multiple discrete layers of similar or dissimilar polyolefins or other polymers may be assembled to form the separator 18. The separator 18 may include a fibrous layer to provide the separator 18 with appropriate structural and porosity characteristics.

Suitable electrolyte solutions for the lithium-based secondary electrochemical device 12 may include nonaqueous solutions of lithium salts. Nonlimiting examples of suitable lithium salts include lithium hexafluorophosphate, lithium hexafluoroarsenate, lithium bis(trifluoromethlysulfonylimide), lithium bis(trifluorosulfonylimide), lithium trifluoromethanesulfonate, lithium fluoroalkylsulfonimides, lithium fluoroarylsulfonimides, lithium bis(oxalate borate), lithium tris(trifluoromethylsulfonylimide)methide, lithium tetrafluoroborate, lithium perchlorate, lithium tetrachloroaluminate, lithium chloride, and combinations of these.

The lithium salt may be dissolved in a non-aqueous, inert solvent, which may be selected from: ethylene carbonate, propylene carbonate, butylene carbonate, dimethyl carbonate, diethyl carbonate, ethylmethyl carbonate, methylpropyl carbonate, butylmethyl carbonate, ethylpropyl carbonate, dipropyl carbonate, cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, or an ionic liquid, and mixtures of two or more of these solvents.

In addition, although not shown, the lithium-based secondary electrochemical device 12 may further optionally include other components, such as, but not limited to, gaskets, seals, and terminal caps, for performance-related or other practical purposes. The lithium-based secondary electrochemical device 12 may also be connected in a combination of series and/or parallel electrical connections with other similar lithium-based secondary electrochemical devices 12 to produce a suitable voltage output and current.

During operation of the lithium-based secondary electrochemical device 12, a chemical redox reaction may transfer electrons between a region of relatively negative potential to a region of relatively positive potential to thereby cycle, i.e., charge and discharge, the lithium-based secondary electrochemical device 12 to provide voltage to power applications. In particular, a plurality of lithium ions may transfer between the positive electrode 110 and the negative electrode 10 during charging and discharging of the lithium-based secondary electrochemical device 12, as set forth in more detail below.

The lithium-based secondary electrochemical device 12 can generate a useful electric current during discharge by way of reversible electrochemical reactions that occur when the negative electrode 10 is connected to the positive electrode 110 via a closed external circuit (not shown). More specifically, an average chemical potential difference between the positive electrode 110 and the negative electrode 10 may drive electrons produced by the oxidation of intercalated lithium at the negative electrode 10 through the external circuit towards the positive electrode 110. Likewise, lithium ions produced at the negative electrode 10 may be carried by the electrolyte solution through the separator 18 (FIG. 3) towards the positive electrode 110. Lithium ions entering the electrolyte solution at the negative electrode 10 may recombine with electrons at a solid-electrolyte interface (not shown) between the electrolyte solution and the positive electrode 110, and the lithium concentration within the positive electrode 110 may increase. Further, the electrons flowing through the external circuit may reduce lithium ions migrating across the separator 18 in the electrolyte solution to form intercalated lithium at the positive electrode 110. The electric current passing through the external circuit may therefore be harnessed until the intercalated lithium in the negative electrode 10 is depleted, and the capacity of the lithium-based secondary electrochemical device 12 is diminished below a useful level for a particular application.

In addition, the lithium-based secondary electrochemical device 12 may be charged or re-charged by applying an external power source to the lithium-based secondary electrochemical device 12 to reverse the aforementioned electrochemical reactions that occur during discharge. More specifically, the external power source may initiate an otherwise non-spontaneous oxidation of intercalated lithium at the positive electrode 110 to produce electrons and lithium ions. The electrons, which may flow back towards the negative electrode 10 through the external circuit, and the lithium ions, which may be carried by the electrolyte solution across the separator 18 (FIG. 3) and back towards the negative electrode 10, may reunite at the negative electrode 10 and replenish the negative electrode 10 with intercalated lithium for consumption during a subsequent discharge cycle.

Referring now to FIG. 2, the electrode 10 of the lithium-based secondary electrochemical device 12 (FIG. 1) includes the current collector 22. The current collector 22 includes a substrate 24 (FIG. 5A) having a surface 26 (FIG. 5A) defining a plurality of pores 28 (FIG. 5B) therein. The substrate 24 may be selected according to a desired application of the lithium-based secondary electrochemical device 12. As non-limiting examples, the substrate 24 may be formed from an element selected from Groups 4-11, Period 4 of the periodic table of the elements. Alternatively, the substrate 24 may be formed from aluminum. As best shown in FIG. 6, the substrate 24 may be porous. By way of non-limiting examples, the substrate 24 may be a copper foam (shown generally at 124 in FIG. 6) or a copper mesh. In other non-limiting examples, for forming the current collector 22 for the negative electrode 10, the substrate 24 may be a titanium foam or a nickel foam. By way of other non-limiting examples, for forming the current collector 122 for the positive electrode 110, the substrate 24 may be an aluminum foam or a stainless steel foam. Further, each of the plurality of pores 28 (FIG. 5B) may have an average diameter of from about 1 nanometer to about 50 nanometers, wherein 1 nanometer is equal to 1×10⁻⁹ meter.

Referring to FIG. 5A, the substrate 24 may have a thickness 30 of from about 5 microns to about 25 microns, wherein 1 micron is equal to 1×10⁻⁶ meter. For example, for a negative electrode 10, the substrate 24 may be a copper foam 124 (FIG. 6) having a thickness 30 of about 10 microns. For a positive electrode 110, the substrate 24 may be an aluminum foam having a thickness 30 of about 20 microns. Moreover, the surface 26 of the substrate 24 may be configured for receiving and supporting a material during, for example, a coating operation, as set forth in more detail below.

Referring now to FIGS. 2 and 5C, the current collector 22, 122 (FIG. 2) also includes a lithium powder 32 (FIG. 5C) disposed within each of the plurality of pores 28 (FIG. 5B). The lithium powder 32 may be formed from a metallic lithium foil and may be pulverized to powder form, or may be a stabilized metallic powder protected by a surface coating (not shown) such as lithium carbonate.

Referring now to FIGS. 2 and 5D, the current collector 22, 122 (FIG. 2) may also include a sealing layer 34, 134 (FIG. 5D) disposed on the surface 26 and formed from a carbon paste, wherein the sealing layer 34, 134 covers the lithium powder 32 and the surface 26. That is, the sealing layer 34, 134 may surround and contact the lithium powder 32 disposed within each of the plurality of pores 28 (FIG. 5B). Stated differently, the sealing layer 34, 134 may encapsulate the lithium powder 32, substantially fill and seal off each of the plurality of pores 28, lock the lithium powder 32 within each of the plurality of pores 28, and thereby form a non-porous contact surface of the current collector 22, 122.

Referring to FIG. 2, the electrode 10 also includes a cured film 36, 136 disposed on the current collector 22, 122, e.g., disposed on the sealing layer 34, 134, and formed from an electrically-conductive material. That is, the cured film 36, 136 may cover or coat the sealing layer 34, 134, as set forth in more detail below. In addition, although not shown, the cured film 36, 136 may also be disposed on or coat additional surfaces 48, 50 that are each adjacent, adjoining, or spaced apart from the surface 26 of the substrate 24.

The cured film 36, 136 (FIG. 2) may be configured for incorporating a plurality of lithium ions (not shown) during charging of the lithium-based secondary electrochemical device 12 (FIG. 1) to a lithiated state (not shown), and releasing the plurality of lithium ions during discharge of the lithium-based secondary electrochemical device 12 to a non-lithiated state (not shown). That is, the cured film 36, 136 may be capable of accepting the plurality of lithium ions during charging, and releasing the plurality of lithium ions during discharging of the lithium-based secondary electrochemical device 12. Stated differently, the electrically-conductive material of the cured film 36, 136 may be capable of lithiation and de-lithiation. As used herein, the terminology “lithiation” refers to the transfer and incorporation of the plurality of lithium ions to the negative electrode 10 during charging of the lithium-based secondary electrochemical device 12. Conversely, as used herein, the terminology “de-lithiation” refers to the extraction or release of the plurality of lithium ions from the negative electrode 10, and transfer of the plurality of lithium ions to the positive electrode 110 during discharging of the lithium-based secondary electrochemical device 12.

As such, the electrically-conductive material may include any lithium host material that can sufficiently undergo lithium intercalation and deintercalation during operation of the lithium-based secondary electrochemical device 12 (FIG. 1). Examples of electrically-conductive materials include electrically conductive carbonaceous materials such as carbon, graphite, carbon nanotubes, graphene, and petroleum coke, as well as transition metals and their oxides such as titanium dioxide, tin oxide, iron oxides, and manganese dioxide, or silicon and silicon oxides. Mixtures of such electrically-conductive materials may also be used. In a non-limiting example, the electrically-conductive material may be graphite. Commercial forms of graphite that may be used to form the cured film 36, 136 are available from, for example, Timcal Graphite & Carbon of Bodio, Switzerland; Lonza Group of Basel, Switzerland; and Superior Graphite of Chicago, Ill.

The cured film 36, 136 (FIG. 2) may also include a binder in sufficient amount to structurally hold the electrically-conductive material together. Nonlimiting examples of suitable binders may be formed from polymers such as, but not limited to, polyvinylidene fluoride, polyacrylonitrile, polyethylene oxide, polyethylene, polypropylene, polytetrafluoroethylene, polybutadiene, polystyrene, polyalkyl acrylates and methacrylates, ethylene-(propylene-diene-monomer)-copolymer (EPDM) rubber, copolymers of styrene and butadiene, and mixtures of such polymers.

For embodiments of the positive electrode 110 (FIG. 2), the binder may include at least one material with functional groups selected from alkali and alkaline earth salts of acid groups and hydroxyl groups, amine groups, isocyanate groups, urethane groups, urea groups, amide groups, and combinations of these. The aforementioned materials may be used in any combination.

In general, for forming the cured film 136 of the positive electrode 110, the electrically-conductive material may be selected from one or more of three kinds of materials: a layered oxide such as lithium cobalt oxide (LiCoO₂); a polyanion such as lithium iron phosphate; and a spinel such as lithium manganese oxide. In some embodiments the positive electrode 110 may comprises a lithium-transition metal compound of formula LiMPO₄, wherein M is at least one transition metal of the first row of transition metals in the periodic table of the elements, more preferably a transition metal selected from Mn, Fe, Ni, and Ti, or a combination of these elements. Other useful lithium-containing electrically-conductive materials are lithium-containing transition metal compounds such as lithium-containing mixed transition metal oxides. Other examples of useful electrically-conductive materials for forming the cured film 136 of the positive electrode 110 may include lithium nickelate (LiNiO₂), lithium-containing nickel-cobalt-manganese oxides with layer structure, and manganese-containing spinels doped with one or more transition metals, including those having a formula LiₐM_{b}Mn_{3-a-b}O_{4-d} in which 0.9≦a≦1.3, preferably 0.95≦a≦1.15; 0≦b≦0.6 when M is Ni, preferably 0.4≦b≦0.55; −0.1≦d≦0.4, preferably 0≦d≦0.1; and M is selected from Al, Mg, Ca, Na, B, Mo, W, transition metals from the first row of the periodic table of the elements, and combinations of these, preferably Ni, Co, Cr, Zn, and Al, and more preferably Ni; and manganese-containing mixed transition metal oxides with layer structure especially including Mn, Co, and Ni. Further, the lithium-transition metal compound may be present in a particulate form, for example in the form of nanoparticles. The nanoparticles may have any shape, such as approximately spherical, or may be elongated.

The cured film 136 of the positive electrode 110 may also include a carbonaceous material. For example, electrically-conductive, high-surface-area carbon black may ensure electrical connectivity between the current collector 122 and the electrically-active material in the cured film 136 of the positive electrode 110.

Referring now to FIG. 7, in another embodiment, the electrode 10 may further include a plurality of surfaces 26, 126 each spaced opposite and apart from one another and defining the plurality of pores 28 (FIG. 5B) therein. As such, the current collector 22, 122 may further include a plurality of sealing layers 34, 134 each disposed on a respective one of the plurality of surfaces 26, 126 and formed from the carbon paste, wherein each of the plurality of sealing layers 34, 134 covers the lithium powder 32 and a respective one of the plurality of surfaces 26, 126. Likewise, the electrode 10 may further include a plurality of cured films 36, 136 each disposed on a respective one of the plurality of sealing layers 34, 134 and formed from the electrically-conductive material.

Referring now to FIG. 4, a method 38 of forming the electrode 10, 110 for the lithium-based secondary electrochemical device 12 is also disclosed. The method 38 includes defining 40 the plurality of pores 28 (FIG. 5B) in the surface 26 (FIG. 5A) of the substrate 24 (FIG. 5A). The plurality of pores 28 may be defined in the surface 26 by any process. By way of a non-limiting example, defining 40 the plurality of pores 28 may include roughening the substrate 24, such as by sanding the surface 26. In another non-limiting example, defining 40 the plurality of pores 28 may include electrochemically depositing an element onto the substrate 24, wherein the element is selected from the group consisting of aluminum and Groups 4-11, Period 4 of the periodic table of the elements. That is, the plurality of pores 28 may be defined in the surface 26 by electrodeposition. For example, the plurality of pores 28 may be defined by electrochemically depositing copper onto a copper foil substrate to form a copper foam (shown generally at 124 in FIG. 6). Similarly, the plurality of pores 28 may be defined by electrochemically depositing aluminum onto an aluminum foil substrate. Generally, defining 40 the plurality of pores 28 may also include controlling a size of the plurality of pores 28 and a depth (not shown) of the plurality of pores 28 with respect to the surface 26, 126 so that comparatively large voids may be avoided.

With continued reference to FIG. 4, the method 38 also includes inserting 42 the lithium powder 32 (FIG. 5C) into each of the plurality of pores 28 (FIG. 5B). In one non-limiting example, inserting 42 may include spraying the lithium powder 32 into each of the plurality of pores 28.

Referring again to FIG. 4, after inserting 42, the method 38 may further include, after inserting 42, depositing 44 the sealing layer 34 (FIG. 5D) formed from the carbon paste onto the lithium powder 32 (FIG. 5C) and the surface 26 (FIG. 5D). That is, depositing 44 may include covering and surrounding the lithium powder 32 with the sealing layer 34 so that the sealing layer 34 surrounds and contacts, e.g., encapsulates or envelops, the lithium powder 32. Depositing 44 may include casting the sealing layer 34 onto the lithium powder 32 and the surface 26.

With continued reference to FIG. 4, the method 38 further includes, after inserting 42 and optionally depositing 44, forming 46 the cured film 36 comprising the electrically-conductive material on the current collector 22, 122 (FIG. 2) to thereby form the electrode 10, 110. That is, after inserting 42 and before forming 46, the sealing layer 34 (FIG. 5D) may deposited onto the lithium powder 32 as set forth above. Subsequently, the cured film 36 may be formed to cover the sealing layer 34. For example, the cured film 36 (FIG. 2) may be formed by a doctor blade process in which the sealing layer 34 is coated with a slurry of the electrically-conducting material comprising, based on 100 parts by weight of the slurry, about 80 parts by weight of a lithium transition metal compound, about 10 parts by weight carbon black, and about 10 parts by weight of a binder comprising polyvinylidene to form a slurry layer (not shown). The slurry layer may subsequently be heated to a suitable curing temperature, for example, in an oven, to form the cured film 36 and thereby form the electrode 10, 110.

The aforementioned lithium-based secondary electrochemical devices 12 have excellent energy density and substantially mitigate any capacity loss at a solid-electrolyte interphase during initial cycling. That is, the electrodes 10, 110 may minimize lithium loss during initial cycling. Further, the electrodes 10, 110 may provide a source of lithium ions, and minimize dendrite formation. The electrodes 10, 110 may also minimize heat generated from contact between the cured film 36, 136 and lithium metal. In addition, the method 38 as described herein provides for excellent distribution of the lithium powder 32 and does not require solvents having compatibility with the lithium powder 32. Therefore, the electrodes 10, 110 and method 38 provide lithium-based secondary electrochemical devices 12 having extended operating life.

While the best modes for carrying out the disclosure have been described in detail, those familiar with the art to which this disclosure relates will recognize various alternative designs and embodiments for practicing the disclosure within the scope of the appended claims.

1. An electrode for a lithium-based secondary electrochemical device, the electrode comprising:
a current collector including;
a substrate having a surface defining a plurality of pores therein; and
a lithium powder disposed within each of the plurality of pores; and
a cured film disposed on the current collector and formed from an electrically-conductive material.

2. The electrode of claim 1, wherein the current collector further includes a sealing layer disposed on the surface and formed from a carbon paste, wherein the sealing layer covers the lithium powder and the surface and the cured film covers the sealing layer.

3. The electrode of claim 2, wherein the sealing layer surrounds and contacts the lithium powder.

4. The electrode of claim 1, wherein the substrate is formed from an element selected from Groups 4-11, Period 4 of the periodic table of the elements.

5. The electrode of claim 4, wherein the substrate is a copper foam.

6. The electrode of claim 4, wherein the substrate is a copper mesh.

7. The electrode of claim 4, wherein the substrate is a titanium foam.

8. The electrode of claim 4, wherein the substrate is a nickel foam.

9. The electrode of claim 1, wherein the substrate is an aluminum foam.

10. The electrode of claim 1, wherein the substrate is a stainless steel foam.

11. The electrode of claim 1, further including a plurality of surfaces each spaced opposite and apart from one another and defining the plurality of pores therein.

12. The electrode of claim 11, wherein the current collector further includes a plurality of sealing layers each disposed on a respective one of the plurality of surfaces and formed from the carbon paste, wherein each of the plurality of sealing layers covers the lithium powder and a respective one of the plurality of surfaces.

13. The electrode of claim 12, further including a plurality of cured films each disposed on a respective one of the plurality of sealing layers and formed from the electrically-conductive material.

14. The electrode of claim 1, wherein the electrode is a positive electrode of the lithium-based secondary electrochemical device.

15. The electrode of claim 1, wherein the electrode is a negative electrode of the lithium-based secondary electrochemical device.

16. A method of forming an electrode for a lithium-based secondary electrochemical device, the method comprising:
defining a plurality of pores in a surface of a substrate;
inserting a lithium powder into each of the plurality of pores to form a current collector; and
after inserting, forming a cured film comprising an electrically-conductive material on the current collector to thereby form the electrode.

17. The method of claim 16, wherein defining includes electrochemically depositing an element onto the substrate, wherein the element is selected from the group consisting of aluminum and Groups 4-11, Period 4 of the periodic table of the elements.

18. The method of claim 16, wherein inserting includes spraying the lithium powder into each of the plurality of pores.

19. The method of claim 16, further including, after inserting and before forming, depositing a sealing layer formed from a carbon paste onto the lithium powder and the surface.

20. A lithium-based secondary electrochemical device comprising:
a positive electrode;
a negative electrode spaced opposite the positive electrode; and
a separator positioned between the positive electrode and the negative electrode;
wherein at least one of the positive electrode and the negative electrode includes;
a current collector including;
a substrate having a surface defining a plurality of pores therein; and
a lithium powder disposed within each of the plurality of pores; and
a cured film disposed on the current collector and formed from an electrically-conductive material.
